(19) United States
(12) Patent Application Publication
(10) Pub. No.: US 2025/0259028 A1
(43) Pub. Date: Aug. 14, 2025

(54) IMAGE FORMING APPARATUS CAPABLE OF ADDING CHANGE TO WHITE REGION OF OUTPUT TARGET IMAGE TO REGENERATE OUTPUT TARGET IMAGE AND NON-TRANSITORY COMPUTER-READABLE RECORDING MEDIUM WITH IMAGE PROCESSING PROGRAM STORED THEREIN

(71) Applicant: KYOCERA Document Solutions Inc., Osaka (JP)

(72) Inventors: Averustin AVELINO, Osaka (JP); Nathalie Elaine BARGAMENTO, Osaka (JP)

(73) Assignee: KYOCERA Document Solutions Inc., Osaka (JP)

(21) Appl. No.: 19/049,152

(22) Filed: Feb. 10, 2025

(30) Foreign Application Priority Data
Feb. 14, 2024 (JP) 2024-020712

(51) Int. Cl. G06K 15/02; B41J 2/21; B41J 11/00

(52) U.S. Cl. CPC G06K 15/1878; B41J 2/21; B41J 11/0095; G06K 15/1882; G06K 2215/0094; G06K 2215/101

(57) ABSTRACT

An image forming apparatus includes: an image forming device and a control device. The control device functions as: a white region extractor that extracts a white region from an output target image; a high-brightness region extractor that extracts a high-brightness region adjacent to the white region; a color change determiner that determines whether a change in image of the high-brightness region toward the white region is a first change from lower to higher brightness or a second change from higher to lower brightness; a region generator that, in the case of the first change, copies a portion of a higher-brightness subregion of the high-brightness region to generates an adjustment white region; an image regenerator that replaces the white region with the adjustment white region to regenerate the output target image; and a controller that allows the image forming device to form the regenerated output target image on a recording sheet.

### INCORPORATION BY REFERENCE

This application claims priority to Japanese Patent Application No. 2024-020712 filed on 14 Feb. 2024, the entire contents of which are incorporated by reference herein.

### BACKGROUND

The present disclosure relates to image forming apparatuses and image processing programs and particularly relates to a technique for representing a white region consisting of a white image without the use of a toner for white.

Image forming apparatuses that form a white image using a white toner have been proposed. For example, there is known a general image forming apparatus in which, in forming an image on a colored recording sheet with the use of a white toner, an underlying toner layer is inserted between a white toner layer and a colored recording sheet and a toner layer formed by overlaying the white toner layer on the underlying toner layer is fixed on the recording sheet. In this manner, the above general image forming apparatus prevents penetration of the white toner into the recording sheet due to the fixation.

### SUMMARY

A technique improved over the aforementioned technique is proposed as one aspect of the present disclosure.

An image forming apparatus according to an aspect of the present disclosure includes an image forming device and a control device. The image forming device forms an image on a recording sheet. The control device includes a processor and functions, through the processor executing a control program, as a white region extractor, a high-brightness region extractor, a color change determiner, a region generator, an image regenerator, and a controller. The white region extractor extracts from an output target image a white region consisting of a white image for each of predetermined segmented regions of the output target image. The high-brightness region extractor extracts, from among the segmented regions adjacent to the white region in the output target image, a high-brightness region formed of a segmented region consisting of an image having a higher brightness. The color change determiner determines whether a change in pixel value of the image within the high-brightness region toward the adjacent white region is a first change from lower brightness to higher brightness or a second change from higher brightness to lower brightness. When the color change determiner determines that the change in pixel value of the image within the high-brightness region is the first change, the region generator copies a portion of a subregion located in a higher-brightness side of the high-brightness region and generates from the copied portion an adjustment white region having a size corresponding to a size of the white region. The image regenerator replaces the white region with the adjustment white region to regenerate the output target image. The controller allows the image forming device to form the regenerated output target image on the recording sheet.

A non-transitory computer-readable recording medium according to another aspect of the present disclosure stores an image processing program. When, in a computer including an image forming device that forms an image on a recording sheet and a processor, the processor executes the image processing program, the image processing program allows the computer to operate as a white region extractor, a high-brightness region extractor, a color change determiner, a region generator, an image regenerator, and a controller. The white region extractor extracts from an output target image a white region consisting of a white image for each of predetermined segmented regions of the output target image. The high-brightness region extractor extracts, from among the segmented regions adjacent to the white region in the output target image, a high-brightness region formed of a segmented region consisting of an image having a higher brightness. The color change determiner determines whether a change in pixel value of the image within the high-brightness region toward the adjacent white region is a first change from lower brightness to higher brightness or a second change from higher brightness to lower brightness. When the color change determiner determines that the change in pixel value of the image within the high-brightness region is the first change, the region generator copies a portion of a subregion located in a higher-brightness side of the high-brightness region and generates from the copied portion an adjustment white region having a size corresponding to a size of the white region. The image regenerator replaces the white region with the adjustment white region to regenerate the output target image. The controller allows the image forming device to form the regenerated output target image on the recording sheet.

### BRIEF DESCRIPTION OF THE DRAWINGS

FIG. 1 is a cross-sectional view of an image forming apparatus.

FIG. 2 is a block diagram showing an example of an internal configuration of the image forming apparatus.

FIG. 3 is a flowchart showing white representation processing according to a first embodiment of the present disclosure.

FIG. 4 is a diagram illustratively showing an output target image and its segmented regions.

FIGS. 5 and 6 are diagrams illustratively showing a portion of the output target image including a high-brightness region and a white region.

FIG. 7 is a diagram showing the process of generating an adjustment white region.

FIG. 8 is a diagram showing the process of replacing the white region with the adjustment white region to regenerate the output target image.

FIG. 9 is a diagram showing the process of generating a reversed adjustment white region.

FIG. 10 is a diagram showing the process of generating a compensation white region.

FIG. 11 is a diagram showing the process of regenerating the output target image using the reversed adjustment white region and the compensation white region.

FIG. 12 is a view illustrating the visibility of Craik-O'Brien-Cornsweet illusion.

FIG. 13 is a block diagram showing another example of an internal configuration of the image forming apparatus.

FIG. 14 is a flowchart showing white representation processing according to a second embodiment of the present disclosure.

FIGS. 15A to 15C are views showing an example of reconstruction of an output target image with the use of a background color.

FIG. 16 shows diagrams showing an example of an output target image before and after being subjected to white representation processing.

### DETAILED DESCRIPTION

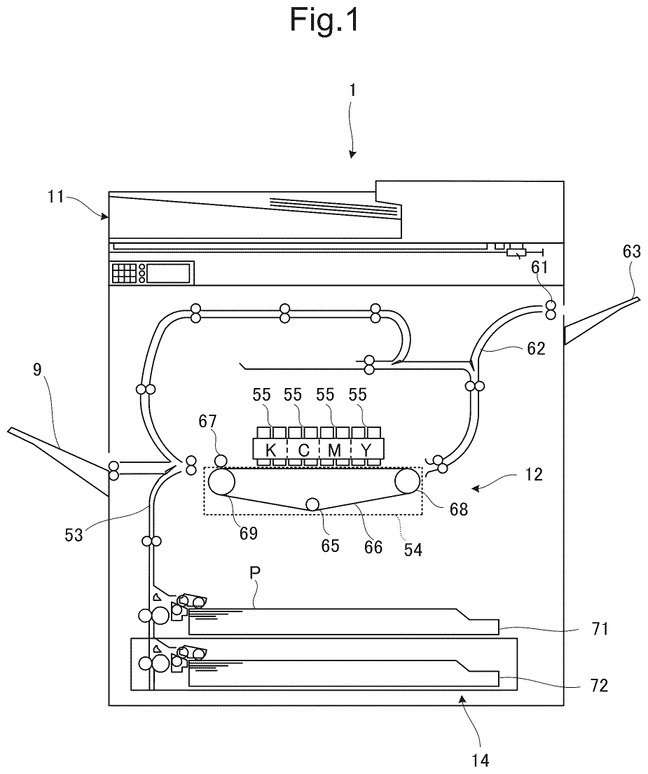

Hereinafter, a description will be given of an image forming apparatus and an image processing program according to the present disclosure with reference to the drawings. FIG. 1 is a cross-sectional view showing an image forming apparatus 1 according to an embodiment of the present disclosure.

As shown in FIG. 1, the image forming apparatus 1 is an MFP (multifunction peripheral) combining a plurality of functions, including a copy function and a scan function. The image forming apparatus 1 includes an image reading device 11 and an image forming device 12.

The image reading device 11 includes an image pickup device (such as a CCD sensor or a contact image sensor) that optically reads an image of an original document. The image reading device 11 generates image data representing the image of the original document from an analog output of the image pickup device.

The image forming device 12 forms, on a recording paper sheet, an image represented by the image data based on an ink-jet system. The image forming device 12 includes line heads 55 (examples of ink heads) that eject ink droplets of four individual colors (black, cyan, magenta, and yellow). Each line head 55 ejects ink droplets of the individual color onto a recording paper sheet P being conveyed from a sheet feeder 14 through a conveyance path 53 to a conveyance unit 54 to form a multicolor image on the recording paper sheet P.

The conveyance unit 54 includes a drive roller 68, a driven roller 69, a tension roller 65, and a conveying belt 66. The conveying belt 66 is an endless belt and is mounted around the drive roller 68, the driven roller 69, and the tension roller 65.

The drive roller 68 is a roller that is driven into clockwise rotation by a motor. When the drive roller 68 is driven into rotation, the conveying belt 66 is traveled in a clockwise loop and, thus, the driven roller 69 and the tension roller 65 are driven into clockwise rotation.

The tension roller 65 is a roller that appropriately holds the tension of the conveying belt 66. An adsorption roller 67 is in contact with the conveying belt 66. The adsorption roller 67 electrically charges the conveying belt 66 to electrostatically attract to the conveying belt 66 a recording paper sheet P being fed from the sheet feeder 14.

The recording paper sheet P with an image of an original document formed thereon by the image forming device 12 is conveyed along an intermediate conveyance path 62 and then ejected through an ejection roller 61 to a sheet output tray 63.

The sheet feeder 14 includes a first sheet feed cassette 71, a second sheet feed cassette 72, and a manual feed tray 9. The sheet feeder 14 feeds and conveys a recording paper sheet P from one of the sheet feed cassettes 71 and 72 to the conveyance path 53 or feeds and conveys a recording paper sheet P from the manual feed tray 9 to the image forming device 12.

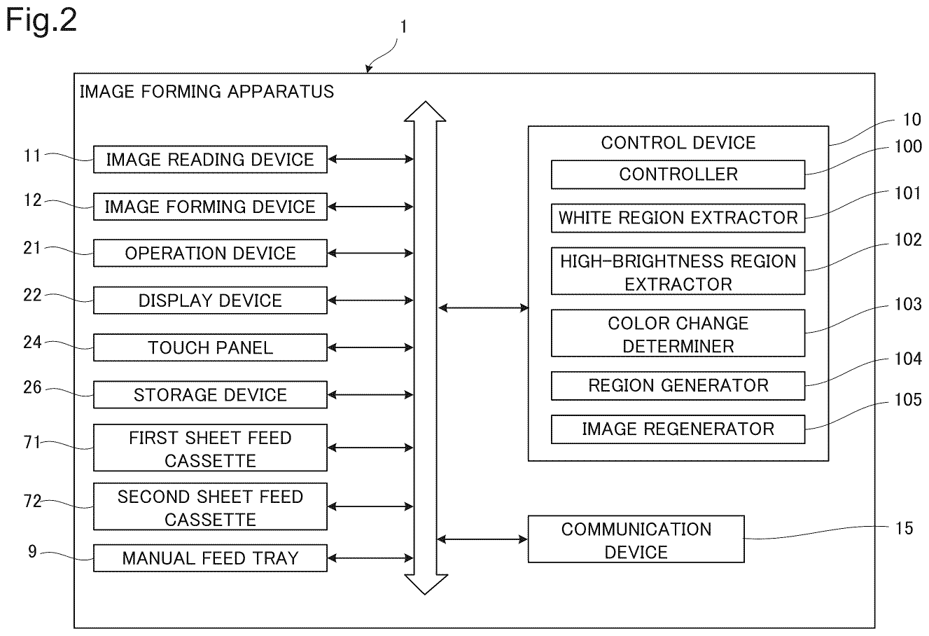

FIG. 2 is a block diagram showing an internal configuration of the image forming apparatus 1. As shown in FIG. 2, the image forming apparatus 1 includes the image reading device 11, the image forming device 12, an operation device 21, a display device 22, a touch panel 24, a storage device 26, the sheet feed cassettes 71 and 72, the manual feed tray 9, a communication device 15, and a control device 10. These components are capable of sending and receiving data or signal from and to each other via a bus.

The operation device 21 includes physical keys, including numeric keys, an Enter key, and a Start key. The display device 22 is composed of a liquid crystal display (LCD), an organic EL (organic light-emitting diode (OLED)) display or the like.

The touch panel 24 is disposed on the screen of the display device 22. The touch panel 24 is a touch panel of, for example, a resistive film system or a capacitance system. The touch panel 24 detects a touch of the touch panel 24 with a user's finger or the like, together with the point of touch, and outputs a detection signal indicating the coordinate of the point of touch to a later-described controller 100 of the control device 28. The touch panel 24 is a portion of the operation device 21.

The storage device 26 is a large-capacity storage device, such as an SSD (solid state drive) or an HDD (hard disk drive). The storage device 26 stores various application programs and various types of data.

The communication device 15 is formed of a communication module or so on. The communication device 15 sends and receives various type of data via a network to and from external devices.

The control device 10 is composed of a processor, a RAM (random access memory), a ROM (read only memory), and so on. The processor is, for example, a CPU (central processing unit), an ASIC or an MPU (micro processing unit). When an operation control program stored in the above-mentioned ROM or storage device 26 is executed by the above-mentioned processor, the control device 10 functions as a controller 100.

Furthermore, when an image processing program stored in the above ROM or storage device 26 is executed by the above processor, the control device 10 functions as a white region extractor 101, a high-brightness region extractor 102, a color change determiner 103, a region generator 104, and an image regenerator 105. Moreover, when the control device 10 executes the image processing program with the above processor, the control device 10 functions as a controller 100 to execute procedures necessary for white representation processing to be described hereinafter and procedures necessary for image formation processing of an output target image obtained by the white representation processing.

The controller 100 provides overall control of the image forming apparatus 1. The controller 100 is electrically connected to the image reading device 11, the image forming device 12, the operation device 21, the display device 22, the touch panel 24, the storage device 26, the communication device 15, the manual feed tray 9, the sheet feed cassettes 71 and 72, and so on. The controller 100 performs control of the operations of these components, and sending and receiving of signal or data to and from these components.

The controller 100 serves as a processing device that executes various types of processing and so on necessary for image formation of the image forming apparatus 1. The controller 100 accepts a user's instruction on operation input based on a detection signal output from the touch panel 24 or an operation on a physical key of the operation device 21. For example, the controller 100 accepts through the touch panel 24 a touch gesture on a GUI (graphical user interface) or the like displayed on the screen of the display device 22.

The controller 100 has the function of controlling the display operation of the display device 22. The controller 100 controls respective drive sources (such as motors) that actuate the respective sheet feed cassettes 71, 72 to allow one of the sheet feed cassettes 71, 72 to feed a recording paper sheet P to the conveyance path 53.

In the image forming apparatus 1, the controller 100 performs an image forming operation by allowing the image reading device 11 to read an image of an original document, allowing the sheet feeder 14 to feed a recording paper sheet P from one of the sheet feed cassettes 71, 72 or the manual feed tray 9, and allowing the image forming device 12 to form image data representing the image of the original document on the recording paper sheet P.

As just described, the controller 100 allows the image forming device 12 to form an image represented by image data generated by the image reading device 11. In allowing the image forming device 12 to form an image on a colored recording paper sheet, the controller 100 allows the image forming device 12 to perform image formation based on image data subjected to white representation processing. The white representation processing refers to image processing that makes it possible to represent a white image by image formation using four-color (black, cyan, magenta, and yellow) inks.

The white representation processing is executed by the white region extractor 101, the high-brightness region extractor 102, the color change determiner 103, the region generator 104, and the image regenerator 105. Hereinafter, the white representation processing will be described. First, a description will be given of procedures for the white representation processing executed by the above-mentioned components. The white region extractor 101 extracts from an output target image a white region consisting of a white image for each of predetermined segmented regions of the output target image,.

The high-brightness region extractor 102 extracts, from among the segmented regions adjacent to the white region extracted for each of predetermined segmented regions of the output target image by the white region extractor 101, a high-brightness region formed of a segmented region consisting of an image having a higher brightness.

The color change determiner 103 determines whether a change in pixel value of the image within the high-brightness region extracted by the high-brightness region extractor 102 toward the adjacent white region is a change from lower brightness to higher brightness or a change from higher brightness to lower brightness.

When the color change determiner 103 determines that the change in pixel value of the image within the high-brightness region is “the change from higher brightness to lower brightness”, the region generator 104 copies a portion of a subregion located in a higher-brightness side of the high-brightness region and generates from the copied portion an adjustment white region having a size corresponding to the size of the white region.

The image regenerator 105 replaces the white region with the adjustment white region generated by the region generator 104 to regenerate the output target image.

The controller 100 allows the image forming device 12 to form on a recording sheet the output target image regenerated by the image regenerator 105.

When the color change determiner 103 determines that the change in pixel value of the image within the high-brightness region is “the change from lower brightness to higher brightness”, the region generator 104 copies a portion of a subregion located in a higher-brightness side of the high-brightness region, generates from the copied portion an adjustment white region having a size corresponding to the size of the white region, reverses the higher-brightness side and the lower-brightness side of the adjustment white region to generate a reversed adjustment white region, and further copies a portion of a subregion located in a lower-brightness side of the reversed adjustment white region to generate a compensation white region.

In this case, the image regenerator 105 regenerates the output target image by replacing the high-brightness region with the reversed adjustment white region and replacing a portion of the higher-brightness region adjacent to the white region with the compensation white regions.

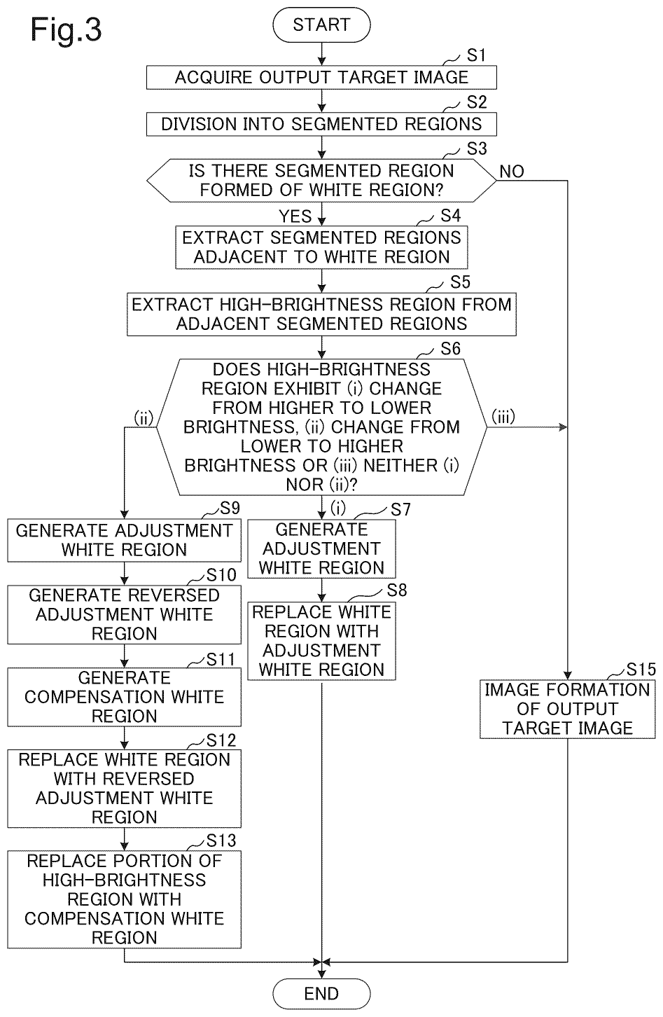

Next, a description will be given of white representation processing according to a first embodiment of the present disclosure. FIG. 3 is a flowchart showing white representation processing according to a first embodiment of the present disclosure.

In executing the white representation processing, the white region extractor 101 acquires, as an output target image, image data generated by the image reading device 11 or image data (print target data) received through the communication device 15 from an external computer or so on (step S1).

The white region extractor 101 divides the output target image into predetermined segmented regions (step S2).

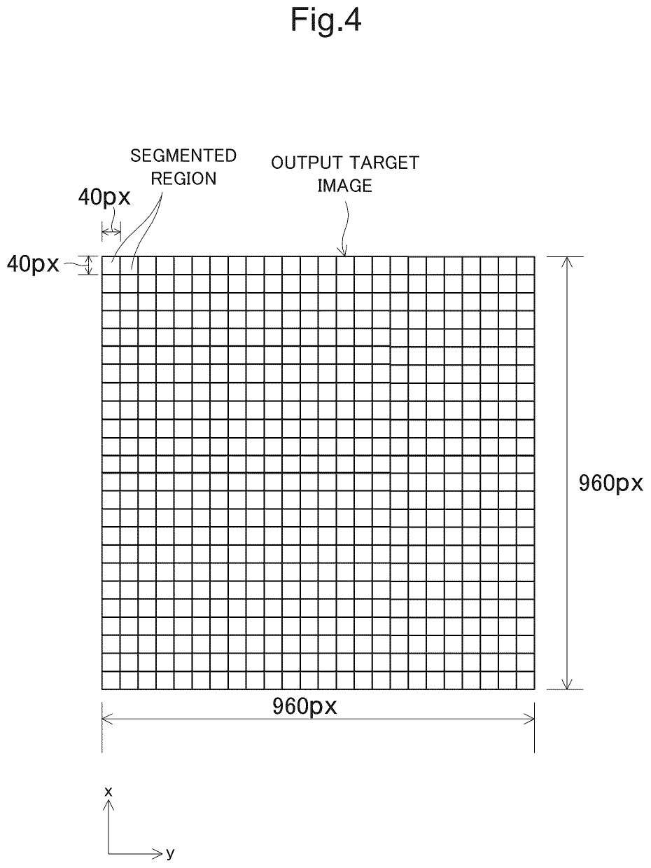

For example, as shown as an example in FIG. 4, when an output target image 40 is composed of 960 pixels (px) in the x direction and 960 pixels (px) in the y direction, the predetermined segmented regions are segmented regions 42 each composed of 40 px in the x direction and 40 px in the y direction. However, the size of the segmented regions is not limited to the above size and can be changed in each of the x direction and the y direction.

The white region extractor 101 determines, for each of the segmented regions, whether or not the segmented region is a white region formed of a white image (step S3). The white region refers to a segmented region where all the pixels within the region have pixel values indicating white or a segmented region where a predetermined proportion (for example, 95%) of all the pixels within the regions have pixel values indicating white. The white region extractor 101 determines, regarding every segmented region contained in the output target image, whether or not the segmented region is a white region.

When the white region extractor 101 extracts no white region from among all the segmented regions contained in the output target image (NO in step S3), the controller 100 allows the image forming device 12 to perform image formation using the output target image acquired in step S1 as it is (step S15).

On the other hand, when the white region extractor 101 extracts one or more white regions from among the segmented regions contained in the output target image (YES in step S3), the high-brightness region extractor 102 extracts, from among the segmented regions contained in the output target image, segmented regions aligned adjacent to each of the white regions (step S4).

Specifically, the segmented regions aligned adjacent to the white region (hereinafter, referred to as the “adjacent segmented regions”) comprise, for example, in the example shown in FIG. 4, a predetermined number of segmented regions adjacent to the white region and aligned in the x direction and a predetermined number of segmented regions adjacent to the white region and aligned in the y direction. For example, when the white region is made up of a plurality of segmented regions aligned in the x direction, the predetermined number is the number by which segmented regions making up the white region are aligned in the x direction. Alternatively, when the white region is made up of a plurality of segmented regions aligned in the y direction, the predetermined number is the number by which segmented regions making up the white region are aligned in the y direction.

The high-brightness region extractor 102 extracts, from among adjacent segmented regions aligned in the x direction and adjacent segmented regions aligned in the y direction, an adjacent segmented region formed of an image having a higher brightness, i.e., a high-brightness region (step S5). The high-brightness region refers to, for example, among adjacent segmented regions in the x direction and adjacent segmented regions in the y direction, a segmented region where a set of pixels of an image forming the segmented region have a higher average pixel value.

The color change determiner 103 determines whether a change in pixel value of the image forming the high-brightness region extracted by the high-brightness region extractor 102 toward the adjacent white region is (i) a change from lower brightness to higher brightness, (ii) a change from higher brightness to lower brightness or (iii) neither (i) nor (ii) (step S6).

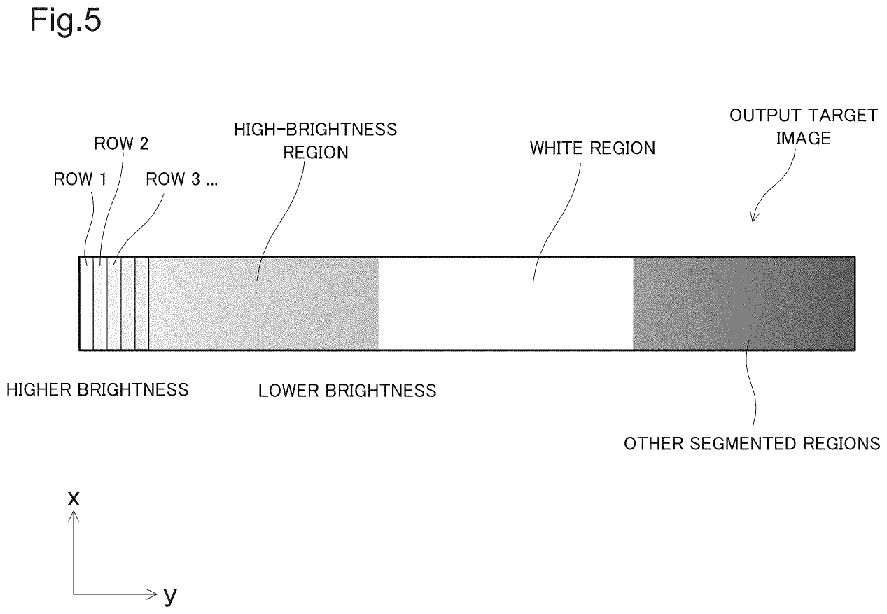

Herein, (i) the change from higher brightness to lower brightness refers to, as shown as an example in FIG. 5, a state that when, with a high-brightness region adjacent to a white region in the y direction, the average of pixel values of each of rows of pixels arranged in the y direction among a set of pixels constituting the image forming the high-brightness region, each row consisting of pixels aligned in the x direction, is calculated, the averages of pixel values of all the rows change from higher value to lower value toward the white region in the y direction. For example, it refers to a state that when a calculation is made of an approximate curve of averages of pixel values of all the rows (row 1, row 2, . . . ) of pixels constituting the high-brightness region, the approximate curve has a downward slope toward the white region. Preferably, the pixel value average of the row of pixels nearest to the white region is the lowest of pixel value averages of all the rows of pixels.

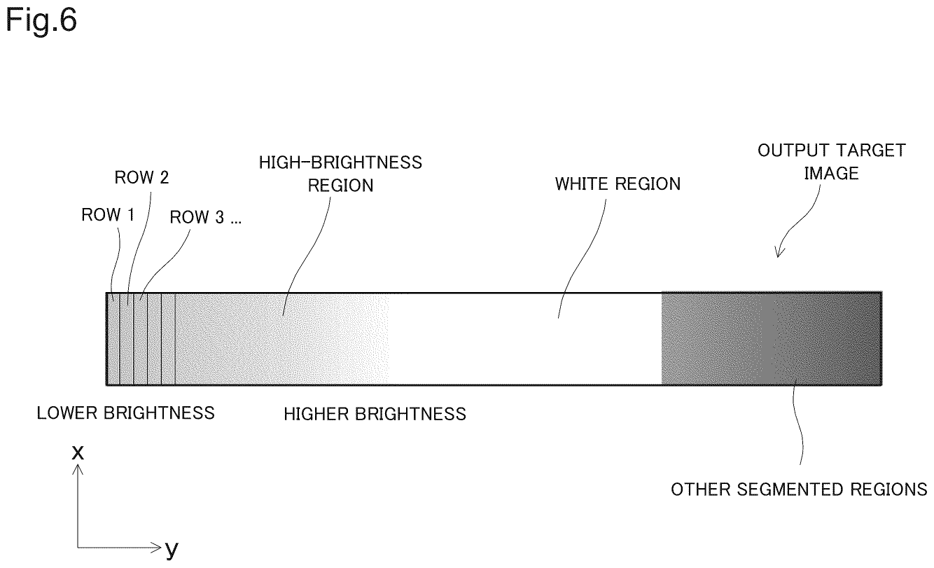

Herein, (ii) the change from lower brightness to higher brightness refers to, as shown as an example in FIG. 6, a state that when, with a high-brightness region adjacent to a white region in the y direction, the average of pixel values of each of rows of pixels arranged in the y direction among a set of pixels constituting the image forming the high-brightness region, each row consisting of pixels aligned in the x direction, is calculated for each of the rows arranged in the y direction, the averages of pixel values of all the rows change from lower value to higher value toward the white region in the y direction. For example, it refers to a state that when a calculation is made of an approximate curve of averages of pixel values of all the rows of pixels constituting the high-brightness region, the approximate curve has an upward slope toward the white region. Preferably, the pixel value average of the row of pixels nearest to the white region is the highest of pixel value averages of all the rows of pixels.

On the other hand, when a high-brightness region is adjacent to a white region in the x direction, the color change determiner 103 calculates the average of pixel values of each of rows of pixels arranged in the x direction among a set of pixels constituting the image forming the high-brightness region, each row consisting of pixels aligned in the y direction, and determines, based on whether the averages of pixel values of all the rows change from lower value to higher value or from higher value to lower value toward the white region in the x direction, whether the change in pixel value of the image forming the high-brightness region is (i) or (ii), in the same manner as in the case where the high-brightness region is adjacent to the white region in the y direction.

When the color change determiner 103 determines “the change from higher brightness to lower brightness” ((i) in step S6), the region generator 104 copies a portion of a subregion located in a higher-brightness side of the high-brightness region in a predetermined direction and generates from the copied portion an adjustment white region having a size corresponding to the size of the white region (step S7).

The higher-brightness side as used herein refers to a side of the high-brightness region that has higher brightnesses than an end portion of the high-brightness region close to the white region (for example, the portion has a width of 10 to 20% of the entire width of the high-brightness region). When the high-brightness region is adjacent to the white region in the x direction, the above predetermined direction is the x direction. When the high-brightness region is adjacent to the white region in the y direction, the above predetermined direction is the y direction.

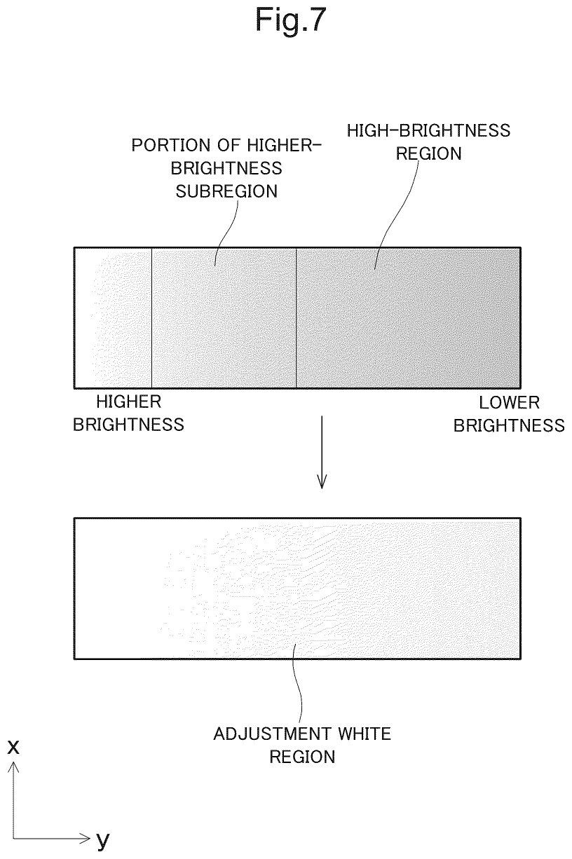

The portion of the subregion located in the higher-brightness side of the high-brightness region is, as shown as an example in FIG. 7, a portion of the high-brightness region that is located in the higher-brightness side of the high-brightness region in the predetermined direction (the y direction in FIG. 7) and has a width of, for example, 30% of the entire width of the high-brightness region in the predetermined direction. The region generator 104 copies the above portion of the high-brightness region and generates from the copied portion an adjustment white region having a size (width) corresponding to the size (width) of the white region in the predetermined direction.

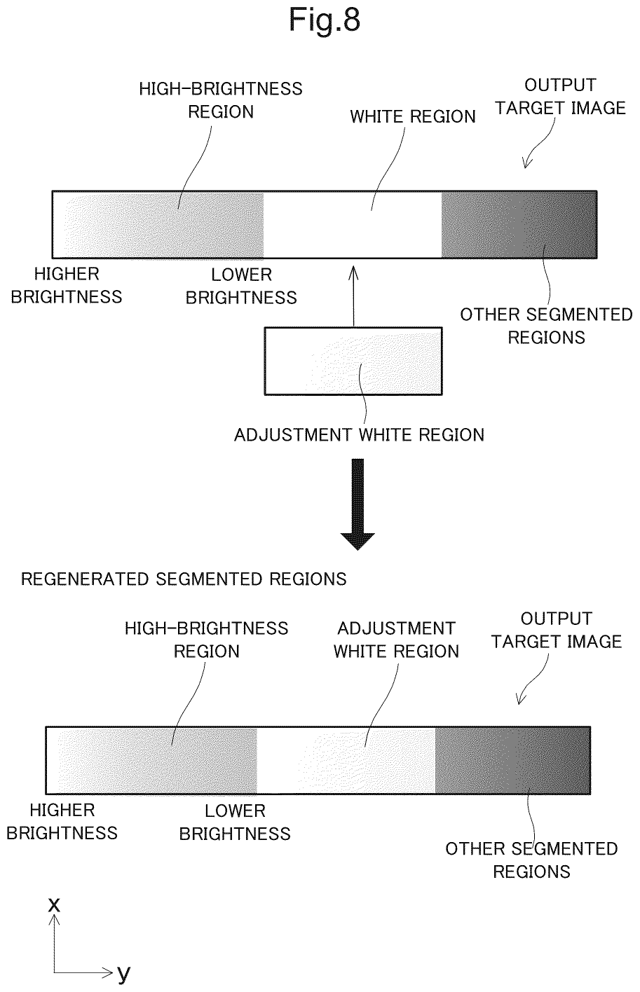

As shown as an example in FIG. 8, the image regenerator 105 replaces the white region with the adjustment white region generated by the region generator 104 to regenerate the output target image consisting of the segmented regions (step S8).

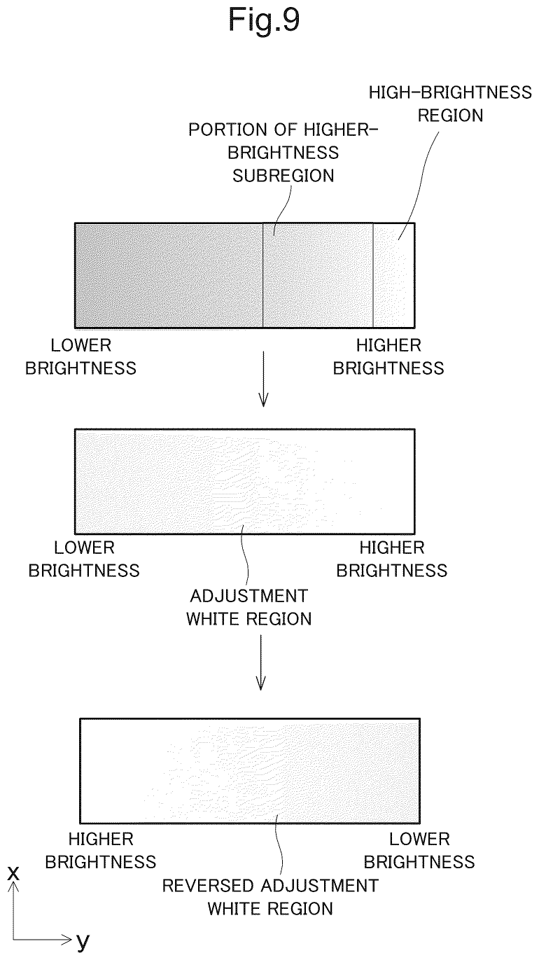

On the other hand, when the color change determiner 103 determines “the change from lower brightness to higher brightness” ((ii) in step S6), the region generator 104 generates an adjustment white region, as shown as an example in FIG. 9, by the same processing as in step S7 (step S9).

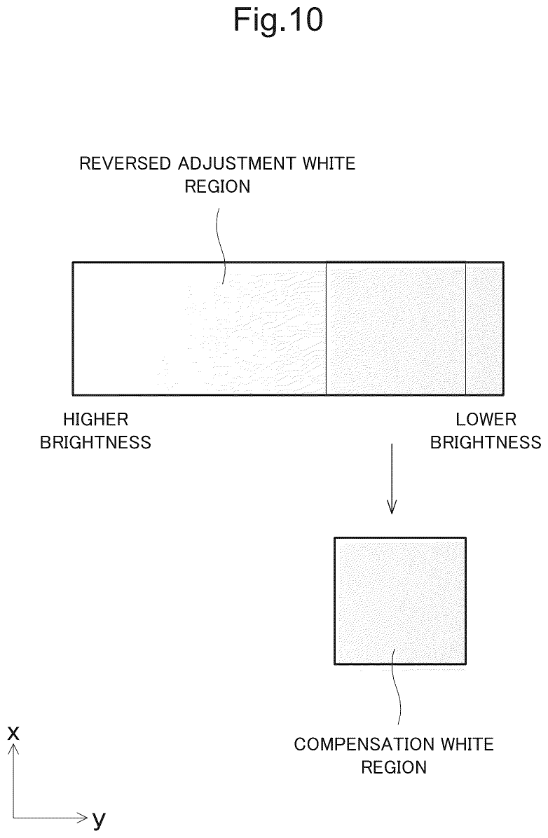

The region generator 104 further generates a reversed adjustment white region by reversing the higher-brightness side and the lower-brightness side of the adjustment white region (step S10). As shown as an example in FIG. 10, the region generator 104 copies a portion of a subregion located in a lower-brightness side of the reversed adjustment white region in the predetermined direction to generate a compensation white region (step S11).

The portion of the subregion located in the lower-brightness side of the reversed adjustment white region is a portion of the reversed adjustment white region where a lower-brightness image is present and which has a width of, for example, 30% of the entire width of the reversed adjustment white region in the predetermined direction. The region generator 104 copies the above portion of the reversed adjustment white region to generate a compensation adjustment white region.

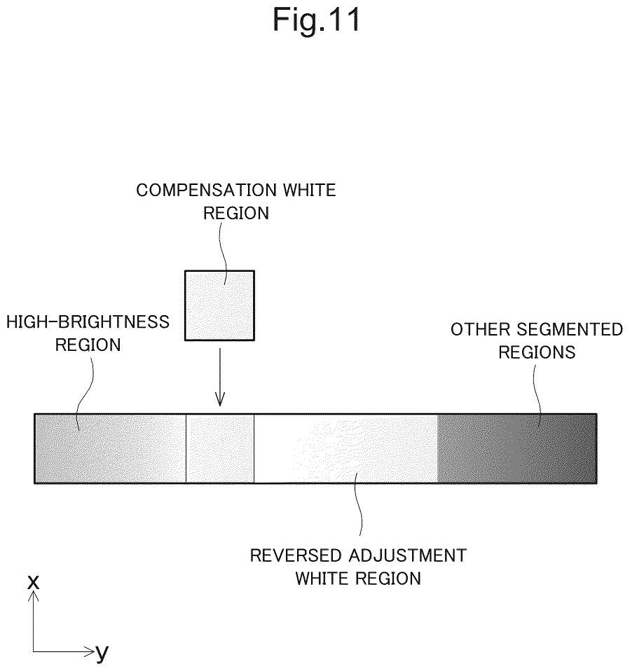

As shown as an example in FIG. 11, the image regenerator 105 regenerates the output target image by replacing the white region with the reversed adjustment white region (step S12) and replacing a portion of the higher-brightness region adjacent to the white region and having the same width as the compensation white region with the compensation white regions (step S13).

When the color change determiner 103 determines “neither (i) nor (ii)” ((iii) in step S6), the controller 100 executes the processing in step S15.

The processing from step S1 to step S15 is executed on all white regions contained in an output target image and all high-brightness regions adjacent to these white regions.

The controller 100 allows the image forming device 12 to form the output target image regenerated through the processing in step S8 or the processing in step S12 on a recording paper sheet, allows a recording medium, such as the storage device 26, to store the output target image or allows the output targe image to be sent through the communication device 15 to an external computer or so on.

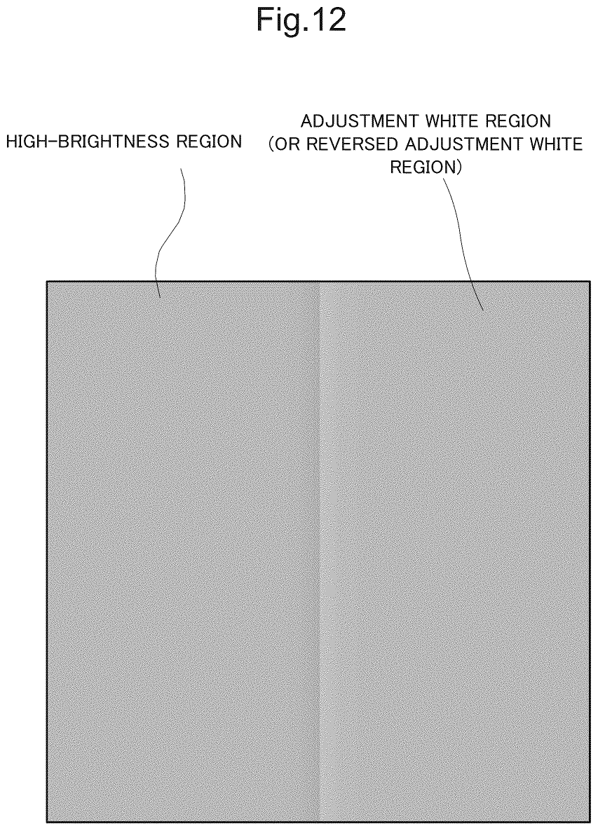

When the output target image is regenerated in step S8 as described above, a boundary portion between the adjustment white region and the high-brightness region adjacent to the adjustment white region exhibits the following abrupt change in brightness of the image in a direction from the high-brightness region toward the adjustment white region as shown as an example in FIG. 12: a decrease in pixel value to a low brightness on a higher-brightness region side of the portion and then an increase in pixel value to a high brightness on an adjustment white region side of the portion.

On the other hand, when the output target image is regenerated in step S12, a boundary portion between the compensation white region of the high-brightness region and the reversed adjustment white region exhibits the following abrupt change in brightness of the image in a direction from the compensation white region toward the reversed adjustment white region: a decrease in pixel value to a low brightness on a compensation white region side of the portion and then an increase in pixel value to a high brightness on a reversed adjustment white region side of the portion.

Thus, under the effect of Craik-O'Brien-Cornsweet illusion, the adjustment white region (or the reversed adjustment white region) is visually recognized to be brighter (have a higher brightness) than the adjacent high-brightness region (or compensation white region) by the person who views it. Therefore, even though the adjustment white region (or the reversed adjustment white region) is represented in colors using pixel values of pixels within the high-brightness region (or the compensation white region), it is visually recognized as a color closer to white than the high-brightness region (or the compensation white region) by the person who views it.

Meanwhile, in order that the general image forming apparatus described previously forms a white image, a white toner and a mechanism for forming an image with the white toner are necessary. Therefore, a general image forming apparatus for forming a colored image cannot form an image using a white toner unless it includes a mechanism for forming an image with the white toner.

Unlike the above, in this embodiment, color representation approximate to a white image can be achieved, without using a white toner, with the use of general color toners for formation of multi-color image and a mechanism for image formation using these color toners. In addition, by making color representation using pixel values of pixels within a high-brightness region (or a compensation white region), i.e., by representing an approximately white color using not a white ink but color inks for formation of multi-color images, even in forming an image on a colored recording sheet, an image of an approximately white color can be formed and such an image having a color representation approximate to a white image can be visually recognized by the person who views the image.

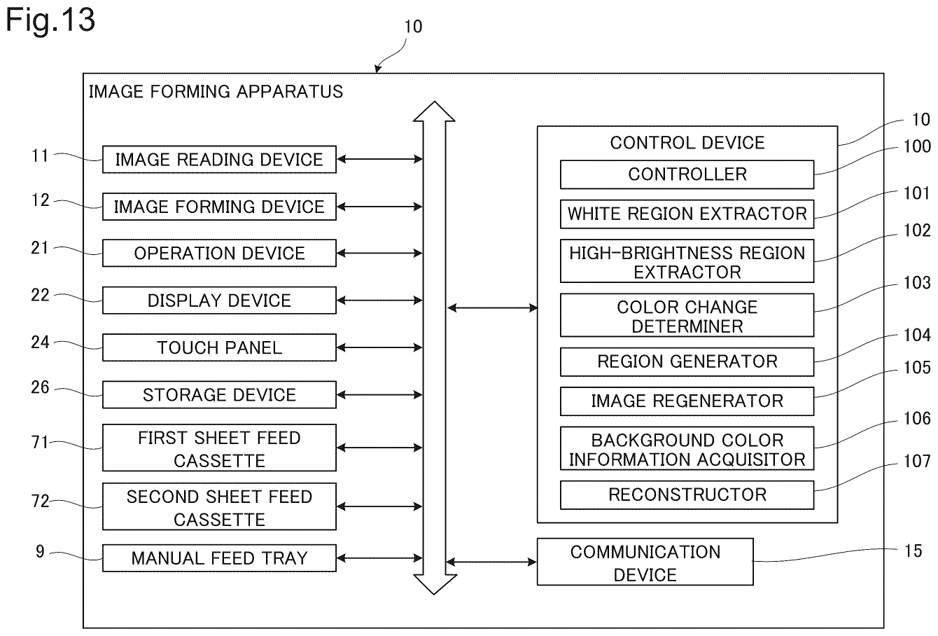

Next, a description will be given of white representation processing according to a second embodiment of the present disclosure. The white representation processing according to the second embodiment is white representation processing suitable for formation of an image on a colored recording sheet. FIG. 13 is a block diagram showing an internal configuration of an image forming apparatus 1 for use in executing the white representation processing according to the second embodiment.

As shown in FIG. 13, when an image processing program stored in the above ROM or storage device 26 is executed by the above processor, the control device 10 further functions as a background color information acquisitor 106 and a reconstructor 107.

The background color information acquisitor 106 acquires background color information indicating the background color of a recording paper sheet for use in image formation of the image forming device 12. For example, background color information is input to the operation device 21 based on a user's operation of the operation device 21. The background color information acquisitor 106 acquires the background color information through the operation device 21. The background color information indicates a predetermined color which is, for example, yellow, magenta, cyan, red, blue or beige.

The reconstructor 107 uses pixel values obtained by subtracting, from each of the pixel values of an output target image, the pixel value of the background color indicated by the background color information acquired by the background color information acquisitor 106 to reconstruct the output target image. The reconstructor 107 allows, for example, the storage device 26 to store the respective predetermined default pixel values of various background colors indicated by background color information.

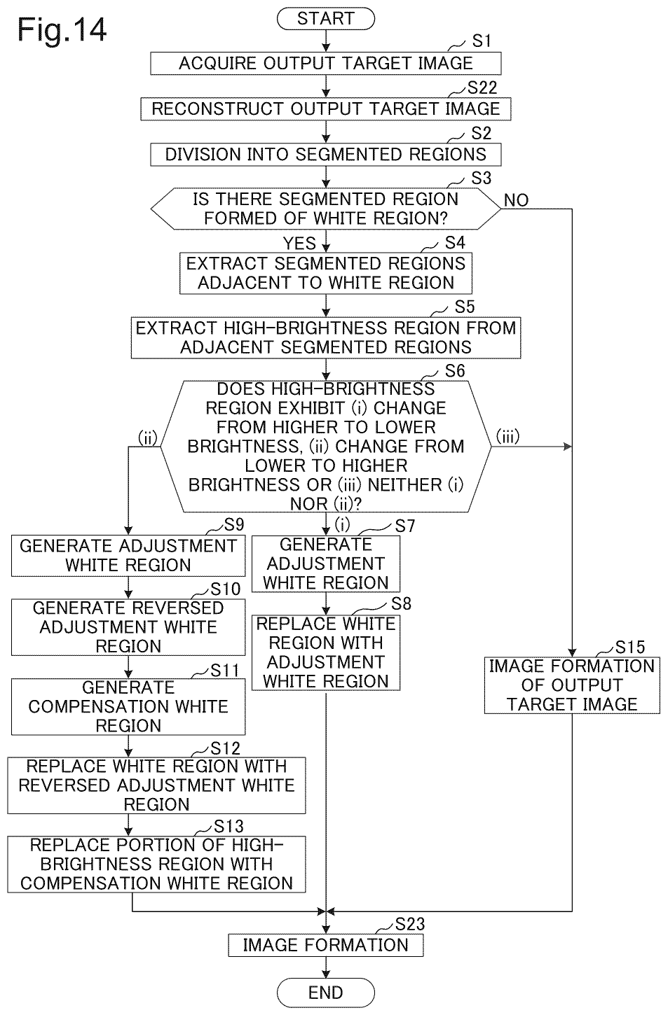

FIG. 14 is a flowchart showing the white representation processing according to the second embodiment. Hereinafter, a description will be given of the white representation processing according to the second embodiment with reference to FIG. 14.

In the white representation processing according to the second embodiment, first, the white region extractor 101 acquires, as an output target image, image data generated by the image reading device 11 or image data (print target data) received through the communication device 15 from an external computer or so on (step S1).

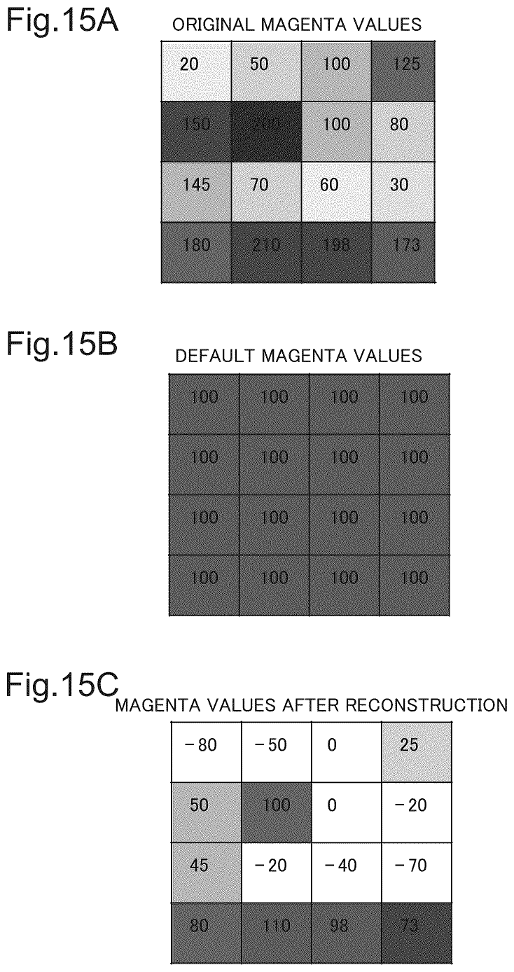

The reconstructor 107 identifies the default pixel value of the background color of a recording sheet indicated by background color information acquired by the background color information acquisitor 106 and uses pixel values obtained by subtracting the above default pixel value from each of the pixel values of an output target image to reconstruct the output target image (step S22). FIGS. 15A to 15C show an example of reconstruction of an output target image using a background color. FIGS. 15A to 15C show the respective pixel values of pixels in terms of magenta component of CMYK values of the image when the background color indicated by background color information acquired by the background color information acquisitor 106 is magenta. In FIGS. 15A to 15C, the pixel values are indicated by numerical values ranging from a minimum of 0 to a maximum of 255.

Assume that the background color indicated by background color information is magenta and the default value of magenta is a pixel value of 100 as shown in FIG. 115. For example, assume that the pixel values of the pixels of the output target image in terms of magenta component of the CMYK values are as shown in FIG. 15A. In this case, in forming the output target image on a recording paper sheet, the recording paper sheet itself represents magenta consisting a pixel value of 100.

Therefore, the reconstructor 107 uses pixel values obtained by subtracting the default pixel value of 100 from the pixel values of the respective magenta components of the pixels of the output target image to reconstruct the pixel values of the pixels in terms of magenta component as shown in FIG. 15C. FIG. 15C includes pixel values of negative numbers, but negative pixel values cannot be represented with CMYK inks. Hence, the reconstructor 107 converts each of the negative pixel values to a pixel value of zero.

After the processing of reconstruction in step S22, the processing in step S2 and subsequent steps is executed in the same manner as with the first embodiment. In other words, in the second embodiment, the white representation processing is executed based on the reconstructed output target image. After the processing in step S13, step S8 or step S15, the controller 100 allows the image forming 12 to perform image formation of the output target image subjected to the white representation processing (step S23).

In forming an image on a colored recording paper sheet, because the recording paper sheet is colored by a background color, such as magenta, it is difficult to represent a white color brighter than the background color on the recording paper sheet based on an output target image. Also in the second embodiment, as for white regions, an image of an approximately white color can be formed by the white representation processing and such an image having a color representation approximate to a white image can be visually recognized by the person who views the image.

As seen from the above, in the second embodiment, since image formation is performed using an output target image subjected to white representation processing based on a reconstructed output target image, a well-reproducible image formation can be achieved while a color element represented by a colored recording paper sheet itself is added to color representation. In addition, even in forming an image on a colored recording paper sheet, an image of an approximately white color can be formed and such an image having a color representation approximate to a white image can be visually recognized by the person who views the image.

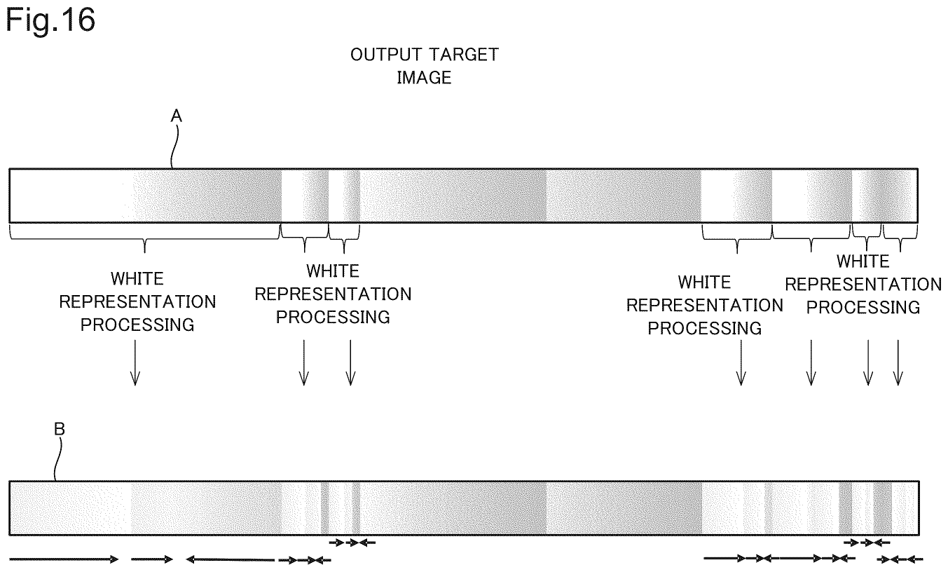

When, with the use of the white representation processing according to the first and second embodiments, white regions of an output target image A and high-brightness regions thereof adjacent to the white regions are subjected to the white representation processing as shown in FIG. 16, the white regions present in various locations of the output target image A are converted to adjustment white regions (or reversed adjustment white regions) and, thus, an output target image B is generated. As a result, the white regions are visually recognized to be brighter (have a higher brightness) than the adjacent high-brightness regions (or compensation white regions). Therefore, the adjustment white regions (or the reversed adjustment white regions) are visually recognized, although not as a perfect white, but as a color close to white by the person who views them.

The white representation processing according to the first embodiment is applicable not only to the above-described image forming apparatus 1 based on an ink-jet system, but also to an image forming apparatus based on an electrophotographic system. The white representation processing according to the second embodiment is applicable to the above-described image forming apparatus 1 based on an ink-jet system.

The white representation processing according to the second embodiment is processing suitable for formation of an image on a recording paper sheet, but is also applicable to storage of an output target image subjected to the white representation processing into the storage device 26 or the like or sending of an output target image through the communication device 15 to an external device.

The present disclosure is not limited to the configuration of the above embodiments and modification and can be modified in various ways. The structures, configurations, and processing of the above embodiments described with reference to FIGS. 1 to 16 are merely illustrative of the present disclosure and the present disclosure is not intended to be limited to the above structures, configurations and processing.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an image forming device that forms an image on a recording sheet; and
a control device including a processor,
the control device functioning, through the processor executing a control program, as:
a white region extractor that extracts from an output target image a white region consisting of a white image for each of predetermined segmented regions of the output target image;
a high-brightness region extractor that extracts, from among the segmented regions adjacent to the white region in the output target image, a high-brightness region formed of a segmented region consisting of an image having a higher brightness;
a color change determiner that determines whether a change in pixel value of the image within the high-brightness region toward the adjacent white region is a first change from lower brightness to higher brightness or a second change from higher brightness to lower brightness;
a region generator that, upon determination of the color change determiner that the change in pixel value of the image within the high-brightness region is the first change, copies a portion of a subregion located in a higher-brightness side of the high-brightness region and generates from the copied portion an adjustment white region having a size corresponding to a size of the white region;
an image regenerator that replaces the white region with the adjustment white region to regenerate the output target image; and
a controller that allows the image forming device to form the regenerated output target image on the recording sheet.

2. The image forming apparatus according to claim 1, wherein when the color change determiner determines that the change in pixel value of the image within the high-brightness region is the second change,
the region generator copies a portion of a subregion located in a higher-brightness side of the high-brightness region and generates from the copied portion an adjustment white region having a size corresponding to the size of the white region, reverses the higher-brightness side and a lower-brightness side of the adjustment white region to generate a reversed adjustment white region, and copies a portion of a subregion located in a lower-brightness side of the reversed adjustment white region to generate a compensation white region, and
the image regenerator regenerates the output target image by replacing the high-brightness region with the reversed adjustment white region and replacing a portion of the high-brightness region adjacent to the white region with the compensation white region.

3. The image forming apparatus according to claim 1, wherein
the image forming device forms the image based on an ink-jet system,
the control device further functions as:
a background color information acquisitor that acquires background color information indicating a background color of the recording sheet; and
a reconstructor that reconstructs the output target image using pixel values obtained by subtracting a pixel value of the background color indicated by the background color information from pixel values of the output target image, and
the white region extractor, the high-brightness region extractor, the color change determiner, the region generator, and the image regenerator execute processing using the output target image reconstructed by the reconstructor.

4. The image forming apparatus according to claim 1,
further comprising:
an operation device to which a user's instruction is to be input; and
a storage device that stores predetermined default pixel values of a plurality of predetermined background colors,
wherein the background color information acquisitor acquires the background color information through the operation device, and
the reconstructor reads from the storage device the default pixel value of the background color indicated by the acquired background color information and reconstructs the output target image using pixel values obtained by subtracting the read default pixel value from the pixel values of the output target image.

5. A non-transitory computer-readable recording medium with an image processing program stored therein, wherein when, in a computer including an image forming device that forms an image on a recording sheet and a processor, the processor executes the image processing program, the image processing program allows the computer to operate as:
a white region extractor that extracts from an output target image a white region consisting of a white image for each of predetermined segmented regions of the output target image;
a high-brightness region extractor that extracts, from among the segmented regions adjacent to the white region in the output target image, a high-brightness region formed of a segmented region consisting of an image having a higher brightness;
a color change determiner that determines whether a change in pixel value of the image within the high-brightness region toward the adjacent white region is a first change from lower brightness to higher brightness or a second change from higher brightness to lower brightness;
a region generator that, upon determination of the color change determiner that the change in pixel value of the image within the high-brightness region is the first change, copies a portion of a subregion located in a higher-brightness side of the high-brightness region and generates from the copied portion an adjustment white region having a size corresponding to a size of the white region;
an image regenerator that replaces the white region with the adjustment white region to regenerate the output target image; and
a controller that allows the image forming device to form the regenerated output target image on the recording sheet.

6. The non-transitory computer-readable recording medium according to claim 5, wherein the image processing program allows the computer to further operate so that when the color change determiner determines that the change in pixel value of the image within the high-brightness region is the second change,
the region generator copies a portion of a subregion located in a higher-brightness side of the high-brightness region and generates from the copied portion an adjustment white region having a size corresponding to the size of the white region, reverses the higher-brightness side and a lower-brightness side of the adjustment white region to generate a reversed adjustment white region, and copies a portion of a subregion located in a lower-brightness side of the reversed adjustment white region to generate a compensation white region, and
the image regenerator regenerates the output target image by replacing the high-brightness region with the reversed adjustment white region and replacing a portion of the high-brightness region adjacent to the white region with the compensation white region.
